(19) United States
(12) Patent Application Publication
(10) Pub. No.: US 2009/0072449 A1
(43) Pub. Date: Mar. 19, 2009

(54) COMPOSITE MATERIAL FORMATION

(75) Inventors: Simon Harry Shepherd, Gloucestershire (GB); Peter John Mellersh, Gloucestershire (GB)

Correspondence Address: SMITH-HILL AND BEDELL, P.C., 16100 NW CORNELL ROAD, SUITE 220, BEAVERTON, OR, 97006, US

(73) Assignee: ALDERLEY MATERIALS LTD, Wotton under Edge, Gloucestershire (GB)

(21) Appl. No.: 11/719,203

(22) PCT Filed: Nov. 11, 2005
(86) PCT No.: PCT/GB2005/004343

§ 371 Date: Aug. 6, 2007

(30) Foreign Application Priority Data
Nov. 13, 2004 (GB) 0425130.2

(51) Int. Cl. B29C 44/02

(52) U.S. Cl. 264/415

(57) ABSTRACT

A method of forming a composite cohesive material. The method including mixing a two part phenolic resin along with a plurality of expandable thermoplastic microspheres. Pouring the mixture into a mould which is then subjected to microwave radiation to substantially cure the material. The microwave radiation also causes expansion of the microspheres. Subsequently the cured material may be dried in a warm room.

This invention concerns a method of forming a composite cohesive material which material includes a resin and expandable polymeric microspheres, and a material made by such a method.

The term “cohesive material” when used in this specification is to be understood as referring to a non particulate material which can be formed in a required shape or form, such as a sheet, board, block, or moulded product.

Syntactic foams are foams created by filling a resinous matrix with a plurality of particles which contain a closed void, such as a hollow sphere. The incorporation of such spheres provides for a reduced density than would otherwise be the case, and can provide advantageous characteristics for use in insulation and/or fire resistance. Such spherical particles also have a reinforcing effect, and this effect is isotropic, in contrast to the directional reinforcement provided by fibrous or lamina reinforcements.

In the case of expandable polymeric microspheres, these are conventionally formed as smaller spheres filled with a volatile hydrocarbon liquid in their unexpanded state. By applying heat, the volatile liquid vapourises and the plastic outer shell softens and expands under pressure from the expanding vapour to provide the microspheres in their expanded state.

Conventionally sheet materials of syntactic foams are formed as follows. The ingredients of the foam are mixed together with the microspheres in an expanded state. This tends to provide a very viscous mixture The mixture is then transferred to a mould. Due to the high viscosity of the mixture, this is a labour intensive and slow process as the material will not flow by itself. The mould therefore has to be hand filled, with the filling process typically taking several man hours per mould. The material has to be spread, compressed and any voids removed by hand in the mould. Material in the mould is then pressed with a mechanical press to squeeze out the bulk water and to shape the product. The shaped product is subsequently oven cured, typically for two days at 60° C. Accordingly, the manufacture of such sheets is a relatively slow and labour intensive process.

According to the present invention there is provided a method of forming a cohesive composite material which material includes a phenolic resin and expanded polymeric microspheres, the method comprising mixing together the components of the material with the polymeric microspheres in an unexpanded state to provide a precursor mixture with at least 2% by weight water and at least 10% by weight expandable polymeric microspheres, locating the mixture in a mould and subjecting the precursor mixture to microwave radiation, which radiation causes the microspheres to enlarge to an expanded state.

The precursor mixture preferably includes 2 to 20% by weight water, and desirably 5 to 10% by weight water.

The unexpanded microspheres are preferably of a type which expand at a temperature of between 85 and 125° C., desirably at a temperature below 100° C., and move desirably at a temperature below 90° C.

The phenolic resin is preferably cured to a substantial extent by the microwave radiation, and may be at least 80% cured by the microwave radiation.

The mould may be closed so as to substantially control the density of the mixture during application of the microwave radiation. The mould may be arranged to permit steam to exit from the material during application of the microwave radiation.

The precursor mixture may be subjected to reduced pressure during application of the microwave radiation.

An air flow may be provided to move steam away during application of the microwave radiation.

Subsequent to application of the microwave radiation, the material may be dried with heat, and the drying may take place at a temperature of between 40 and 80° C., and more desirably around 60° C. The drying may be carried out for a period of between 6 and 18 hours, and may be for around 12 hours.

The microspheres may be formed of a thermoplastic material.

The microspheres may in their expanded state have a specific gravity in the range 0.015 to 0.04, and may have an average diameter in their expanded state of between 30 and 200 microns.

The resin may be in the form of a two-part system, with the two parts of the system being mixed together with the polymeric microspheres in an unexpanded state.

The mould may be rotated and/or turned over during application of the microwave radiation.

The invention also provides a cohesive syntactic foam material made by a method according to any of the preceding twelve paragraphs.

The invention further provides a cohesive insulating material made by a method according to any of said preceding twelve paragraphs.

The material may be in the form of a sheet, board, block or moulded profiled product.

Embodiments of the present invention will now be described by way of example only.

### EXAMPLE 1

A sheet of syntactic foam is formed as follows. A two-part phenolic resin such as AML Resin AMCR-01 with a curing agent such as BP Phencat 15, and water, are mixed together. The mixture also has added to it thermoplastic microspheres in an unexpanded state, and the microspheres can be provided in a proportion of around 25% by weight. The mixture may include a durability enhancer such as glass fibres or glass flake. A fluxing agent such as low melting point glass or zinc borate may be included, as may a fluorinated surfactant.

These components are mixed together using a mixer such as a trifoil, Z blade or dough mixer. The mixture is then poured into a mould, and any rough spreading is carried out as may be required. The mould is then closed and subjected to microwave radiation for example for a period of 2 to 3 minutes. The mould is closed so as to prevent expansion of the mixture, but to allow steam to exit. Under the microwave radiation, the microspheres expand to the expanded state with a diameter of typically 100 microns, whilst water is removed from the phenolic resin.

The sheet thus formed is fully expanded and handleable, but slightly soft. Further drying takes place with heat at for instance 60° C. for around twelve hours to remove further residual water.

### EXAMPLE 2

A sheet with approximate dimensions of 600 mm×600 mm×150 mm is formed as follows. The following precursor mixture, with the source of the components indicated in brackets, is made up and stirred with a power stirrer until fully mixed, as is indicated by a uniform colour distribution. This mixture then has 2% wt of 6 mm chopped strand borosilicate glass fibre reinforcement (Univar) added to it.

The precursor mixture comprises 56% wt phenol formaldehyde resol resin such as AMCR01 (Hexion Chemicals). 2% wt of a silicone surfactant such as DC 193 (Dow Corning) are provided along with 2% wt of a silane coupling agent such as Z6076 (Dow Corning). 36% wt of expandable polymeric microspheres are included such as Expancel 820 DU 40 (Akzo Nobel), which microspheres expand at a temperature of between 84 and 125° C. 2% wt boric acid curing agent is also included.

The total mixture is provided with a wet mix weight of approximately 6.5 Kg, and the material is supplied into a mould. The mould has top and bottom plates with release film provided thereon and a main body. The material is poured into the main body on top of the bottom plate and spread to cover the whole of the bottom plate. The top plate is then placed into position and locked in place.

The loaded mould is rotated in a microwave oven with a nominal 1 m³ cavity, with a turntable and a stirrer acting at a microwave deflector at the top of the oven. Multiple magnetrons are distributed around the microwave cavity, which are individually controllable for power output. The charged mould is placed centrally in the cavity and the turntable rotated. A typical microwave energy programme would be 1 minute at 300 mA, followed by a further 2 minutes at this power, and then 1 minute at 100 mA. The mould may be turned over as well as rotated during the microwave process. An extraction system is provided to remove water vapour and other fumes during application of the microwave energy.

Following application of the microwave energy, the mould is removed 10, from the microwave oven and allowed to cool for approximately 15-20 minutes before the top and bottom plates are removed from the mould main body. The release film should be stripped off from the moulded material soon afterwards. The sheet formed is removed from the mould main body and excess material trimmed off.

The cured sheet will still contain residual water, and is therefore placed in a warm chamber for final drying. The temperature in the chamber is typically between 40 and 50° C., and air circulation and fume extraction is provided. Typically the drying will take place for around 48 hours.

There are thus described examples of methods of making a composite material including expandable microspheres, which methods provide for significant advantages over existing methods. These methods involve significantly less manufacturing time and effort, and particularly due to the reduced viscosity of the initial mixture due to the unexpanded microspheres. Furthermore, the curing time required using microwave radiation, is significantly less than conventionally.

It is largely the water in the precursor mixture which is heated by the microwave energy, and this heat causes the microspheres to expand. Accordingly microspheres are chosen which will expand at around or a little below the boiling point of water.

The microwave energy also cures the resin at least to a substantial degree, such that the resin can hold the expanded microspheres in place. Typically the resin will be 80-90% cured by the microwaves.

The phenol resin produces a material with good fire and heat insulation properties, and also a lack of toxicity. Such material can be used in a wide range of insulation applications, and the material can be provided as sheets, boards or blocks, or could be moulded in particular components by using an appropriately shaped mould.

It is to be realised that various modifications may be made without departing from the scope of the invention. For instance, a wide range of materials and proportions of materials could be used in this process. The different stages of the process could be carried out for different time periods and/or under different conditions. The process can obviously be used for products other than sheets of material.

It may be required for the precursor mixture in the mould to be at a reduced pressure whilst the microwave energy is applied. In addition, or as an alternative, an air flow may be caused across the mould to remove the steam produced during application of the microwave energy.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-25. (canceled)

26. A method of forming a cohesive composite material which material includes a phenolic resin and expanded polymeric microspheres, the method comprising mixing together the components of the material with the polymeric microspheres in an unexpanded state to provide a precursor mixture with at least 2% by weight water and at least 10% by weight expandable polymeric microspheres, locating the mixture in a mould and subjecting the precursor mixture to microwave radiation, which radiation causes the microspheres to enlarge to an expanded state.

27. A method according to claim 26, wherein the precursor mixture includes 2 to 20% by weight water.

28. A method according to claim 27, wherein the precursor mixture includes 5 to 10% by weight water.

29. A method according to claim 26, wherein the unexpanded microspheres are of a type which expand at a temperature of between 85 and 125° C.

30. A method according to claim 29, wherein the unexpanded microspheres are of a type which expand at a temperature of below 100° C.

31. A method according to claim 30, wherein the unexpanded microspheres are of a type which expand at a temperature of below 90° C.

32. A method according to claim 26, wherein the phenolic resin is cured to a substantial extent by the microwave radiation.

33. A method according to claim 32, wherein the phenolic resin is at least 80% cured by the microwave radiation.

34. A method according to claim 26, wherein the mould is closed so as to substantially control the density of the mixture during application of the microwave radiation.

35. A method according to claim 26, wherein the mould is arranged to permit steam to exit from the material during application of the microwave radiation.

36. A method according to claim 26, wherein the precursor mixture is subjected to reduced pressure during application of the microwave radiation.

37. A method according to claim 26, wherein an air flow is provided to move steam away during application of the microwave radiation.

38. A method according to claim 26, wherein subsequent to application of the microwave radiation, the material is dried with heat.

39. A method according to claim 38, wherein the drying takes place at a temperature of between 40 and 80° C.

40. A method according to claim 39, wherein the drying takes place at a temperature of around 60° C.

41. A method according to claim 38, wherein the drying is carried out for a period of between 6 and 18 hours.

42. A method according to claim 41, wherein the drying is carried out for a period of around 12 hours.

43. A method according to claim 26, wherein the microspheres are formed of a thermoplastic material.

44. A method according to claim 26, wherein the microspheres in their expanded state have a specific gravity in the range 0.015 to 0.04.

45. A method according to claim 26, wherein the microspheres have an average diameter in their expanded state of between 30 and 200 microns.

46. A method according to claim 26, wherein the resin is in the form of a two-part system, with the two parts of the system being mixed together with the polymeric microspheres in an unexpanded state.

47. A method according to claim 26, wherein the mould is rotated and/or turned over during application of the microwave radiation.

48. A cohesive syntactic foam material made by a method according to claim 26.

49. A cohesive insulating material made by a method according to claim 26.

50. A material according to claim 48, wherein the material is in the form of a sheet, board, block or moulded profiled product.
